(19) United States
(12) Patent Application Publication
(10) Pub. No.: US 2013/0115187 A1
(43) Pub. Date: May 9, 2013

(54) BIODEGRADABLE MATERIAL CONTAINING SILICON, FOR PRO-ANGIOGENETIC THERAPY

(71) Applicants: Iwer Baecker, Dusseldorf (DE); Christoph Suschek, Langenfeld (DE); Magda Ulrich, Noordbeemster (NL); Bouke Boekema, Bunnik (NL)

(72) Inventors: Iwer Baecker, Dusseldorf (DE); Christoph Suschek, Langenfeld (DE); Magda Ulrich, Noordbeemster (NL); Bouke Boekema, Bunnik (NL)

(73) Assignee: BAYER INNOVATION GMBH, Leverkusen (DE)

(21) Appl. No.: 13/580,359

(22) PCT Filed: Feb. 22, 2011
(86) PCT No.: PCT/EP01/52561

§ 371 Date: Dec. 16, 2012

(30) Foreign Application Priority Data
Feb. 24, 2010 (DE) 10 2010 008 981.8

(51) Int. Cl. C08G 77/14

(52) U.S. Cl. CPC C08G 77/14
USPC 424/78.37; 528/33; 427/2.14

(57) ABSTRACT

The present invention relates to a silicon-containing, biodegradable material for preventing and/or treating diseases that are associated with reduced and/or disturbed angiogenesis and/or diseases for which an increased rate of angiogenesis is beneficial to the healing process.

The present invention relates to a silicon-containing, biodegradable material for preventing and/or treating diseases that are associated with reduced and/or disturbed angiogenesis and/or diseases for which an increased rate of angiogenesis is beneficial to the healing process.

Angiogenesis means the growth of small blood vessels (capillaries), mainly through sprouting from a previously formed capillary system. It is a complex process, in which the endothelial cells, pericytes and smooth muscle cells required for forming the vessel walls are activated by various angiogenic growth factors, for example fibroblast growth factor (FGF) and vascular endothelial growth factor (VEGF). Angiogenesis is of considerable biological and medical importance. A distinction is made in modern medicine between two forms of the therapeutic use of the angiogenesis principle: anti-angiogenic therapy and pro-angiogenic therapy. A pro-angiogenic protein therapy employs growth factors with angiogenic potency, primarily fibroblast growth factor 1 (FGF-1) and vascular endothelial growth factor (VEGF); clinical experience is greatest with these growth factors. However, the growth factors epidermal growth factor (EGF), platelet-derived endothelial cell growth factor (PD-ECGF) and platelet-derived growth factor (PDGF) and transforming growth factor (TGF) also possess a certain angiogenic potency. There is already promising experience in clinical studies in particular with FGF-1: thus, it has been possible to detect new vessels in the human myocardium as well as an improvement in myocardial perfusion (accompanied by an increase in patients' exercise tolerance).

Silicon is a trace element, which in bound silicate form is important for humans. Silicon is a building block of the proteins that are responsible for the strength and elasticity of tissues. It is also incorporated in connective tissues, bone, skin, hair, nails and blood vessels. Moreover, silicon strengthens the body's defence system, the so-called immune system, and promotes wound healing. Silicon deficiency leads to growth disorders, loss of bone stability with increased risk of osteoporosis, as well as premature hair loss, brittle nails and changes in the skin. Possible changes in the skin are increased wrinkle formation, dryness, desquamation, increased cornification, pruritus, thickening and painful cracking of the skin due to reduced elasticity. Moreover, the body's defence system, the so-called immune system, is weakened by silicon deficiency and there is increased susceptibility to infections. Silicon-containing compounds have been described for the prevention or treatment of some diseases. However, it was not known before now that silicon-containing compounds can also induce or promote angiogenic processes and accordingly can be considered for pro-angiogenic therapies.

US2006/0178268A1 describes an aqueous solution consisting of non-colloidal silicic acid and boric acid for treating diseases of bone, cartilage, skin, arteries, connective tissues, joints, hair, nails, and skin, as well as osteoporosis, rheumatic diseases, arteriosclerosis, arthritis, cardiovascular diseases, allergic diseases and degenerative diseases.

US2006/0099276A1 discloses a method of producing a silica derivative by hydrolysis of a silicone compound to oligomers with simultaneous presence of a quaternary ammonium compound, an amino acid or a source of amino acid or combinations thereof. The silica extrudate can be used as pharmaceuticals for treating infections, diseases of the nails, hair, skin, teeth, collagen, connective tissues, and bone, osteopenia, for cell formation for degenerative (ageing) processes.

U.S. Pat. No. 6,335,457B1 discloses a solid substance in which silicic acid is complexed with a polypeptide. This patent also discloses therapeutically usable mixtures comprising this solid substance.

WO2009/018356A1 relates to a mixture comprising a sodium phosphate compound, an ammonium compound and a silicate for preventing or treating diseases such as prostate cancer, colorectal cancer, lung cancer, breast cancer, liver cancer, neuronal cancer, bone cancer, HIV syndrome, rheumatoid arthritis, multiple sclerosis, Epstein-Barr virus, fibromyalgia, chronic fatigue syndrome, diabetes, Bechet's syndrome, irritable bowel syndrome, Crohn's disease, decubitus, trophic ulcers, immune system weakened by radiotherapy or chemotherapy, haematomas or combinations thereof.

WO2009/052090A2 describes a method for treating inflammatory diseases, autoimmune diseases, bacterial or viral infections and cancer, using a composition that contains silicate.

US2003/0018011A1 relates to a pharmaceutical composition with a fatty acid and a water-soluble silicate polymer as anti-allergic or as anti-inflammatory agent.

U.S. Pat. No. 5,534,509 relates to a pharmaceutical composition containing a water-soluble silicate polymer as active agent with a saccharide or sugar alcohol as inert carrier for treating allergies, inflammations, pain or for improving the peripheral blood circulation or paraesthesia.

DE19609551C1 describes the production of bioabsorbable (continuous) fibres based on polyhydroxysilicic acid ethyl ester. The fibres are used as reinforcing fibres for biodegradable and/or bioabsorbable (implant) materials. The fibres can also be used for the production of biodegradable composites.

WO01/42428A1 describes a method of producing skin implant, wherein skin cells are applied on the surface a nutrient solution and are grown with the aid of a surface element consisting of the fibres described in DE19609551C1.

EP1262542A2 relates to a method of in-vitro production of cells, tissues and organs, wherein a fibre matrix is used as cell supporting and/or directing structure according to DE19609551C1.

WO2006/069567A2 relates to a multilayer dressing in which a fibre matrix according to DE19609551C1 is also used in one layer. The multilayer dressing can be used for treating wound defects, such as chronic diabetic-neuropathic ulcer, chronic leg ulcer, bedsores, secondary-healing infected wounds, non-irritating, primary-healing wounds, such as in particular ablative lacerations or abrasions.

WO2008/086970A1, WO2008148384A1, PCT/EP2008/010412 and PCT/EP2009/004806 describe, among other things, the production of other polyhydroxysilicic acid ethyl ester compounds usable according to the invention. The compounds are described generally for use as bioabsorbable materials in human medicine, medical engineering, filter technology, biotechnology or the insulating materials industry. It is also mentioned that the materials can be used advantageously in the area of wound treatment and wound healing. Fibres can be used for example as surgical suture material or as reinforcing fibres. Nonwoven materials can be used in the care of superficial wounds, in the filtration of body fluids (e.g. blood) or as a culture aid in the area of bioreactors.

It is not disclosed in the prior art that the aforementioned biodegradable polyhydroxysilicic acid ethyl ester compounds (e.g. in the form of a fibre or a nonwoven fabric) can be used for preventing and/or treating diseases that are associated with reduced and/or disturbed angiogenesis and/or diseases for which an increased rate of angiogenesis is beneficial to the healing process. The use of polyhydroxysilicic acid ethyl ester compounds for wound treatment and wound healing is described in the aforementioned documents and it is known that wound healing is associated with pro-angiogenic processes, but the prior art does not describe the use of the aforementioned biodegradable polyhydroxysilicic acid ethyl ester compounds in general for pro-angiogenic therapy. This is also surprising in view of the fact, as so far also is not described for other silicon-containing compounds, that these can be used for pro-angiogenic therapy.

The present invention therefore relates to a silicon-containing, biodegradable material for preventing and/or treating diseases that are associated with reduced and/or disturbed angiogenesis and/or diseases for which an increased rate of angiogenesis is beneficial to the healing process, wherein the silicon-containing, biodegradable material is a polyhydroxysilicic acid ethyl ester compound, with the proviso that wound defects, such as chronic diabetic-neuropathic ulcer, chronic leg ulcer, bedsores, secondary-healing infected wounds, non-irritating, primary-healing wounds, such as in particular ablative lacerations or abrasions, are excluded. The invention also comprises the use of a silicon-containing, biodegradable polyhydroxysilicic acid ethyl ester compound according to the invention for producing a medicinal product for preventing and/or treating diseases that are associated with reduced and/or disturbed angiogenesis and/or diseases for which an increased rate of angiogenesis is beneficial to the healing process, with the proviso that wound defects, such as chronic diabetic-neuropathic ulcer, chronic leg ulcer, bedsores, secondary-healing infected wounds, non-irritating, primary-healing wounds, such as in particular ablative lacerations or abrasions, are excluded.

The invention does not include those uses of the material according to the invention that are described in the following patent documents DE19609551C1, WO01/42428A1, EP1262542A2, WO2006/069567A2, WO2008/086970A1, WO2008148384A1, PCT/EP2008/010412 and PCT/EP2009/004806 and are connected with neo-angiogenesis. The use of a polyhydroxysilicic acid ethyl ester fibre nonwoven material as a component of a multilayer dressing was described in WO2006/069567A2 for treating wound defects, such as chronic diabetic-neuropathic ulcer, chronic leg ulcer, bedsores, secondary-healing infected wounds, non-irritating, primary-healing wounds, such as in particular ablative lacerations or abrasions. EP1262542A2 describes various tissue-engineering uses of polyhydroxysilicic acid ethyl ester compounds according to the invention. The term “tissue-engineering uses” according to the present invention is directed at the products, method and uses described in EP1262542A2. Therefore the invention does not include the tissue-engineering uses of the silicon-containing, biodegradable material according to the invention discussed in EP1262542A2, if these are connected with pro-angiogenic therapy.

The term “polyhydroxysilicic acid ethyl ester compound” describes compounds of the general formula H[OSi₈O₁₂(OH)ₓ(OC₂H₅)₆₋ₓ]ₙOH, where x stands for 2 to 5 and n>1 (polymer). The silicon-containing, biodegradable material according to the invention is preferably a material in the form of a fibre, a fibre matrix, powder, monolith and/or coating. A silicon-containing, biodegradable material of this kind can be produced according to the invention as described hereunder:
a) at least one hydrolysis-condensation reaction of tetraethoxysilane,
b) evaporating to produce a single-phase solution preferably with simultaneous gentle mixing of the reaction system,
c) cooling of the single-phase solution and
d) maturation for producing a silica sol material
e) drawing threads from the silica sol material for generating a fibre or a fibre matrix and/or drying and in particular spray drying or freeze-drying of the silica sol material to generate a powder and optionally dissolving the powder in a solvent to generate a liquid formulation and/or coating an object that is to be coated with the silicon-containing, biodegradable material, with the silica sol material, and/or casting the silica sol material in a mould to generate a monolith.

Preferably, according to the invention, the silicon-containing, biodegradable material of the invention is in the form of fibre, fibre matrix (nonwoven fabric), powder, liquid formulation and/or coating.

In another embodiment of the invention, the silicon-containing, biodegradable material according to the invention is produced as described, wherein the tetraethoxysilane is acid-catalysed in step a) at an initial pH from 0 to ≦7, optionally in the presence of a water-soluble solvent, preferably ethanol, at a temperature from 0° C. to 80° C., and in step b) evaporation is carried out to a single-phase solution with a viscosity in the range from 0.5 to 2 Pa·s at a shear rate of 10 s⁻¹ at 4° C.

In another embodiment of the invention, the silicon-containing, biodegradable material is produced as described above, wherein the acid catalysis is carried out in step a) with aqueous solution of nitric acid in a molar ratio to the Si compound in the range 1:1.7 to 1:1.9, preferably in the range from 1:1.7 to 1:1.8. The hydrolysis-condensation reaction in step a) preferably takes place at a temperature from 20 to 60° C., preferably 20 to 50° C. over a period of at least one hour. Preferably the hydrolysis-condensation reaction in step a) proceeds for a period of several hours, for example 8 h or 16 h. However, this reaction can also be carried out for a period of 4 weeks. In a preferred embodiment of the invention, step (b) is carried out in a closed apparatus, in which mixing is possible (preferably rotary evaporator or stirred vessel) with simultaneous removal of the solvent (water, ethanol) by evaporation at a pressure from 1 to 1013 mbar, preferably at a pressure of <600 mbar, optionally with continuous feed of a chemically inert carrier gas for lowering the partial pressure of the evaporating components of 1-8 m³/h (preferably at 2.5 to 4.5 m³/h), a reaction temperature from 30° C. to 90° C., preferably 60 to 75° C., more preferably at 60 to 70° C. and preferably with gentle stirring of the reaction system at up to 80 rev/min (preferably at 20 rev/min to 80 rev/min) up to a viscosity of the mixture of 0.5 to 30 Pa·s at a shear rate of 10 s⁻¹ at 4° C., preferably 0.5 to 2 Pa·s at a shear rate of 10 s⁻¹ at 4° C., especially preferably approx. 1 Pa·s (measurement at 4° C., shear rate 10 s⁻¹). In another embodiment of the invention, the silicon-containing, biodegradable material is cooled in step c) preferably to 2° C. to 4° C. Maturation (step d) preferably also takes place at this low temperature. Maturation may take several hours or days, up to about 3 to 4 weeks. The maturation process in step d) is preferably carried out up to a viscosity of the sol from 30 to 100 Pa·s at a shear rate of 10 s⁻¹ at 4° C. and a loss factor from 2 to 5 (at 4° C., 10 l/s, 1% deformation).

The drawing of threads from the silica sol material in step e) is preferably carried out by a spinning process. Said spinning step can be carried out in usual conditions, as described for example in DE 196 09 551C1 and DE 10 2004 063 599 A1. In a preferred embodiment of the invention, the pressure during spinning of the silica sol material is selected so that a throughput of at least 80 g/h is reached, relative to the total sol throughput.

Preferably, directly after spinning, the spun fibres are exposed for a period from 30 to 60 minutes to the same climatic conditions as in the spinning tower (i.e., for example air humidity of ˜19%, temperature ˜25° C.). This step is called conditioning hereinafter. The fibres obtained by this process are called conditioned fibres.

In another preferred embodiment, the conditioned fibres are exposed, before they are used, to an air humidity of at least 35% (at room temperature) for a period from 1 to 30 minutes and preferably a period from 1 to 10 minutes (see also Table 2).

The drying of the silica sol material for generating powder is preferably carried out by spray drying or freeze-drying. A powder can also be obtained by comminution and grinding of monoliths or also of fibres according to the invention. To generate a liquid formulation, the powder is dissolved in a solvent. Suitable solvents can be aqueous or oily, depending on the application (e.g. solution for injection or suspensions).

An object that is to be coated with the silicon-containing, biodegradable material is preferably coated with the silica sol material by immersing the article to be coated in the silica sol, by sprinkling or by spin-coating or spraying of the silica sol.

The silica sol material according to step d) can also—to generate a monolith—be cast in a mould and then dried.

Further, more-specific information regarding production of the silicon-containing, biodegradable materials according to the invention can be found in DE19609551C1, WO01/42428A1, EP1262542A2, WO2006/069567A2, WO2008/086970A1, WO2008148384A1, PCT/EP2008/010412 and PCT/EP2009/004806.

In the sense of the present invention, the expression “biodegradable” denotes the property of the polyhydroxysilicic acid ethyl ester compound according to the invention to be degraded, when the material is exposed to conditions that are typical of those prevailing during tissue regeneration (for example of a wound). The polyhydroxysilicic acid ethyl ester compound according to the invention is “biologically degradable” or “biodegradable” in the sense of the invention in particular when it dissolves completely after 48 hours, preferably 36 hours and especially preferably after 24 hours in a 0.05 M Tris pH 7.4 buffer solution (Fluka 93371) thermostatically controlled at 37° C.

The term “diseases that are associated with reduced and/or disturbed angiogenesis and/or diseases for which an increased rate of angiogenesis is beneficial to the healing process” describes all those diseases that can be treated (or prevented) by pro-angiogenic therapy. Such diseases comprise:

a) diseases of the blood circulation and of the cardiovascular system such as:
anaemia, angina pectoris, (peripheral) arterial occlusive disease, arteriosclerosis, Winiwarter-Buerger disease, myocardial infarction, ischaemia in particular of the heart muscle, of the lung, cardiomyopathy, congestive heart failure, coronary artery diseases such as coronary restenosis, hereditary haemorrhagic telangiectasia, hypercholesterolaemia, ischaemic heart disease, myocardial scleroderma, myointimal hyperplasia, blocked blood vessels, peripheral arteriosclerotic vascular disease, portal hypertension, preeclampsia, rheumatic heart disease, hypertension, thromboembolic diseases,
   b) diseases associated with bone, cartilage or muscle, such as:
bone/cartilage repair, bone defect, bone fracture, bone growth, cartilage diseases, intervertebral disc degeneration, osteoarthritis, osteoporosis, spinal fracture, fibromyalgia, polymyositis,
   c) diseases of the central nervous system such as:
ischaemia in the central nervous system or in the peripheral nervous system, Alzheimer's, amyotrophic lateral sclerosis, autonomic neuropathy, aneurysms, cerebral infarction, stroke, cerebrovascular disease, cerebrovascular deficient perfusion, dementia, epilepsy, ischaemic peripheral neuropathy, mild cognitive deficits, multiple sclerosis, nerve damage, Parkinson's disease, Niemann-Pick disease, polyneuropathy, schizophrenia, spinal cord injuries, toxic neuropathy;
   d) eye diseases such as:
glaucoma; retinopathy;
   e) gastrointestinal diseases such as:
Crohn's disease, gastric ulcer, intestinal ischaemia, irritable bowel syndrome, pancreatitis, ulcerative colitis;
   f) hormonal or metabolic diseases such as:
diabetes mellitus, diabetic foot, peripheral diabetic vascular disease;
   g) immune system diseases such as:
allergies, mastocytosis, Sjögren disease, transplant rejection, tissue defects in collagenoses such as Sjögren syndrome, dermatomyositis, systemic lupus erythematosus, CREST syndrome, Sharp syndrome;
   h) infectious diseases such as:
septic shock
   i) kidney diseases such as:
nephropathy, intracranial hypertension, renal ischaemia;
   j) oral diseases such as:
dental plaque, gum disease,
   k) diseases of the reproductive system such as:
erectile dysfunction,
   l) diseases of the respiratory tract such as:
asthma, bronchopulmonary dysplasia, pneumonia, respiratory distress syndrome,
   m) skin diseases such as:
nonspecific dermatitis, decubitus ulcers, dermal ischaemia, dermal ulcers, diabetic gangrene, diabetic skin ulcers, lacerations, psoriasis, scleroderma, skin injuries, burns, surgical wounds, wound healing
   n) vascular diseases such as:
vascular insufficiency, vascular restenosis, vasculitis, vasospasm, Wegener's granulomatosis
   o) other diseases such as:
alopecia, lactate acidosis, limb ischaemias, hepatic cirrhosis, hepatic ischaemia, mitochondrial encephalomyopathy, sarcoidosis, soft tissue defects (in particular through accident, operations or malformation), diseases that are treated with autografts of tissues and/or organs.

The term “diseases that are associated with reduced and/or disturbed angiogenesis and/or diseases for which an increased rate of angiogenesis is beneficial for the healing process” describes, in a preferred embodiment, diseases that are selected from the following group:

a) diseases of the blood circulation and of the cardiovascular system such as:
ischaemia in particular of the heart muscle;
   b) diseases of the central nervous system such as:
ischaemia in the central nervous system or in the peripheral nervous system.
   c) oral diseases such as:
dental plaque, gum disease.
   d) soft tissue defects, diseases that are treated with autografts of tissues and/or organs.

The invention also relates to (the use of) silicon-containing, biodegradable materials according to the invention with autografts for treating diseases that are treated with autografts of tissues and/or organs. In this procedure, a silicon-containing, biodegradable material according to the invention is used as a supplement to the autograft in order to achieve improved angiogenesis and therefore quicker incorporation and better acceptance of the autologous graft in the existing tissue.

The invention further relates to a polyhydroxysilicic acid ethyl ester compound with a content of ethoxy groups of at least 20%, preferably of at least 25% and especially preferably between 25 and 30%, as silicon-containing, biodegradable material. Preferably, a polyhydroxysilicic acid ethyl ester compound with this content of ethoxy groups is in the form of a fibre or a fibre matrix.

The content of ethoxy groups is measured by the known standard method of ether cleavage according to Zeisel after spinning, within a period of 1 to 4 weeks after spinning, wherein the polyhydroxysilicic acid ethyl ester compound is stored at reduced air humidity (i.e. for example inside packaging with absorbents as described for example in European patent application EP09007271) during the period before measurement.

Another preferred object of the invention relates to a polyhydroxysilicic acid ethyl ester compound in the form of a fibre or a fibre matrix, where the fibre or the fibre matrix has a compressibility of at least 17%, preferably 20% and especially preferably of at least 25%, as silicon-containing, biodegradable material.

The compressibility is measured by the following steps:

a) measurement of the thickness of the polyhydroxysilicic acid ethyl ester compound in the form of a fibre matrix at least two different pressures,
b) plotting the pairs of measured value (measured thickness and pressure) in a diagram as thickness versus log(pressure),
c) regression according to (d/dₒ)=(p/pₒ)^{-b}, in which pₒ stands for a pressure of 0.25 kPa, dₒ is the calculated thickness of a fibre matrix at pₒ and b is the exponent of the curve,
d) calculation of the compressibility [k] on the basis of regression according to k=(1−d_{1.25}/dₒ), in which d_{1.25} corresponds to the thickness calculated from the regression for 1.25 Pa.

The compressibility is measured within a period of one week after spinning, wherein the polyhydroxysilicic acid ethyl ester compound is stored at reduced air humidity (i.e. for example inside packaging with absorbents) during the time before measurement.

The suitable dosage of the polyhydroxysilicic acid ethyl ester compound is generally in total between 0.001 and 100 mg/kg body weight per day and is administered as a single dose or in multiple doses. A dosage between 0.01 and 25 mg/kg, more preferably 0.1 to 5 mg/kg per day is preferably used. However, the biodegradable properties of the polyhydroxysilicic acid ethyl ester compounds also mean that the compounds can be applied in higher dosages and for example degrade inside the body, e.g. subcutaneously as depot in the form of a monolith, over an extended period and promote pro-angiogenic processes.

The material according to the invention or a precursor thereof (such as for example the silica sol material described above in step d)) can be processed with the carrier substances, fillers, disintegration modifiers, binders, lubricants, absorbents, diluents, flavour correctants, colorants etc. that are usual in pharmaceutics, and transformed into the desired dosage form. Reference may be made to Remington's Pharmaceutical Science, 15th ed. Mack Publishing Company, East Pennsylvania (1980).

The material according to the invention can be administered in a suitable dosage form by the oral, mucosal (for example sublingual, buccal, rectal, nasal or vaginal), parenteral (for example subcutaneous, intramuscular, by bolus injection, intraarterial, intravenous), transdermal route or locally (for example direct application on the skin or topical application on an exposed organ or a wound).

In particular, tablets, coated tablets, film-coated tablets, capsules, pills, powders, granules, pastilles, suspensions, emulsions or solutions may come into consideration for oral application.

Tablets, coated tablets, capsules etc. can be obtained for example as described above by casting the silica sol material obtained in step d) in a tablet-shaped or capsule-shaped mould to generate a monolith. However, the tablets and capsules can also be produced by means of the material according to the invention described above in the form of a powder, by the usual methods. Known excipients, for example inert diluents such as dextrose, sugar, sorbitol, mannitol, polyvinylpyrrolidone, disintegrants such as maize starch or alginic acid, binders such as starch or gelatin, lubricants such as magnesium stearate or talc and/or agents for achieving a depot effect such as carboxypolymethylene, carboxymethylcellulose, cellulose acetate phthalate or polyvinyl acetate can be added to the material according to the invention or a precursor thereof. Tablets can also consist of several layers. Capsules containing the materials according to the invention can for example be produced by mixing the materials according to the invention or a precursor thereof with an inert carrier such as lactose or sorbitol and encapsulating them in gelatin capsules. Correspondingly, coated tablets can be produced by coating cores, produced similarly to the tablets, with agents usually employed in tablet coatings, for example polyvinylpyrrolidone or shellac, gum arabic, talc, titanium dioxide or sugar. The shell of the coated tablets can also consist of several layers, wherein the excipients mentioned above for tablets can be used.

For parenteral application, injection and infusion preparations are possible. For intraarticular injection, correspondingly prepared crystal suspensions can be used. For intramuscular injection, liquid formulations such as aqueous and oily solutions for injection or suspensions and corresponding depot preparations find application. For rectal administration, the materials according to the invention can be used in the form of suppositories, capsules, solutions (e.g. in the form of enemas) and ointments both for systemic and for local therapy. Furthermore, agents for vaginal use may also be mentioned as preparations. Liquid formulations such as solutions for injection or suspensions can be obtained for example by adding suitable aqueous or oily solvents to the material according to the invention described above in the form of a powder. Other types of production are known by a person skilled in the art. Solutions or suspensions of the material according to the invention can additionally contain taste improving agents such as saccharin, cyclamate or sugar and for example flavourings such as vanillin or orange extract. They can in addition contain suspending aids such as sodium carboxymethylcellulose or preservatives such as p-hydroxybenzoate. Suitable suppositories can be produced for example by mixing the appropriate carriers such as neutral fats or polyethylene glycol or derivatives thereof. The solutions described can for example also be used for treating dental plaque or gum disease (e.g. by injection or for rinsing the oral cavity).

Patches are possible for transdermal application, or formulations as gels, ointments, fatty ointments, creams, pastes, powder, milk and tinctures for topical application. Plasters preferably consist of fibres or a fibre matrix (nonwoven fabric) made from the materials according to the invention, as described in the prior art.

In another embodiment of the invention, the material according to the invention or a precursor thereof can be coated by a coating process, for example by dipping an object or article to be coated in the silica sol material described above in step d), by sprinkling or by spin-coating or spraying said silica sol material. Preferably, the silica sol material is applied on implants, autografts, vascular prostheses, dental prostheses or heart valves and especially preferably on autografts, dental prostheses and heart valves.

The aforementioned dosage forms can also contain other active pharmaceutical ingredients, which can be added during the production process.

### LEGENDS

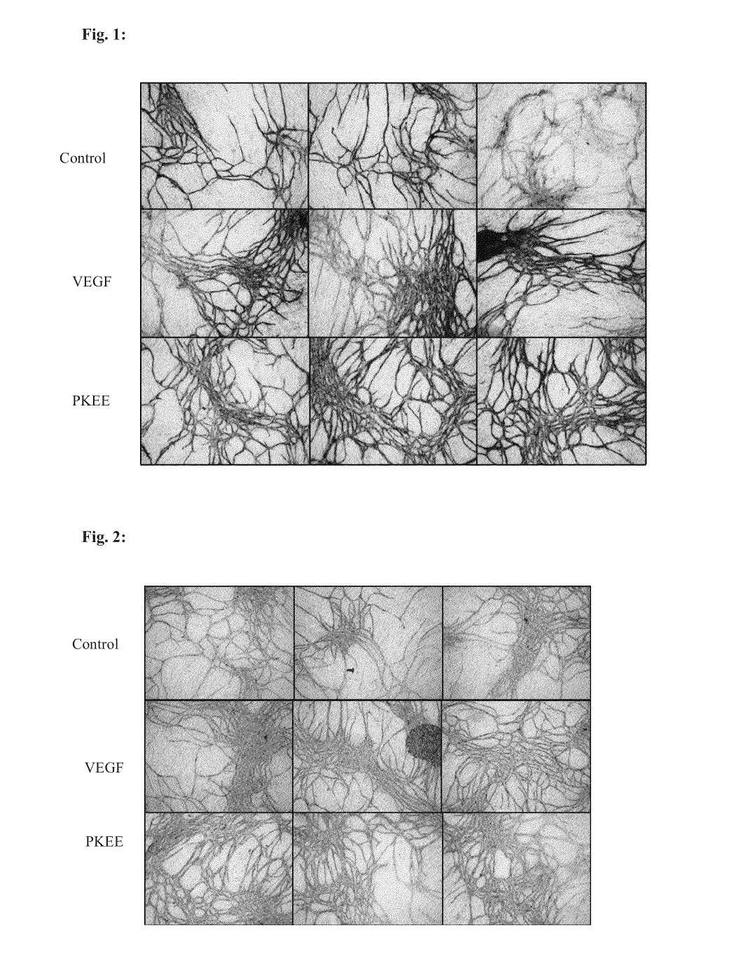

FIG. 1: Neo-angiogenesis on adding VEGF and material according to the invention (PKEE=polyhydroxysilicic acid ethyl ester compound) in the form of a fibre matrix to human endothelial cells (in vitro) detected with specific antibodies to the surface marker CD31. The control shows neo-angiogenesis of human endothelial cells without addition of VEGF or PKEE (negative control).

FIG. 2: Neo-angiogenesis on adding VEGF and material according to the invention (PKEE=polyhydroxysilicic acid ethyl ester compound) in the form of a fibre matrix (nonwoven fabric) to human endothelial cells (in vitro) detected with specific antibodies to the von Willebrand factor (vWF). K=negative control.

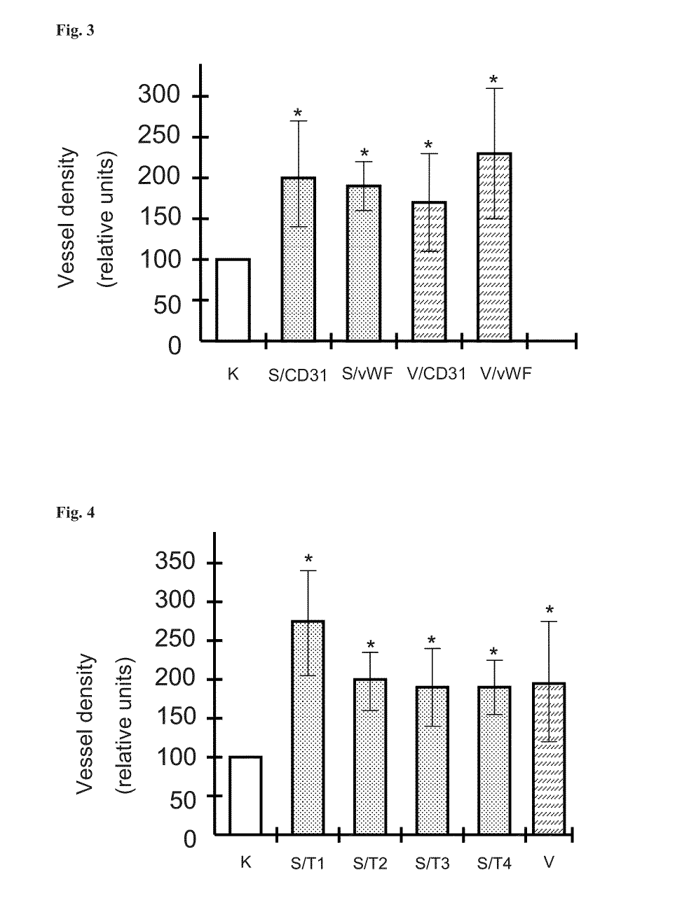

FIG. 3: quantitative evaluation of the neo-angiogenesis of VEGF and material according to the invention in the form of a fibre matrix (nonwoven fabric) in human endothelial cells. K=negative control; S/CD31=material according to the invention and detection of neo-angiogenesis by means of CD31-antibody; S/vWF=material according to the invention and detection of neo-angiogenesis by means of vWF-antibody; V/CD31=VEGF and detection of neo-angiogenesis by means of CD31-antibody; V/vWF=VEGF and detection of neo-angiogenesis by means of vWF-antibody. *=p<0.05 relative to the control (Student t-test).

FIG. 4: Quantitative evaluation of the neo-angiogenesis of VEGF (V) and material according to the invention in the form of a fibre matrix (S/T1=fibre matrix type I; S/T2=fibre matrix type II; S/T3=fibre matrix type III; S/T4=fibre matrix type IV, see production Ex. 1) in human endothelial cells taking into account the staining of the microvessels with an anti-vWF antibody. K=negative control; *=p<0.05 relative to the control (Student t-test).

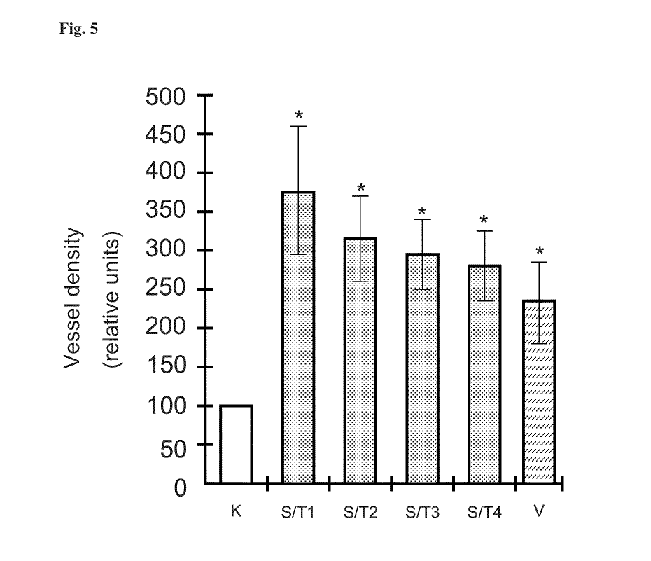

FIG. 5: Quantitative evaluation of the neo-angiogenesis of VEGF (V) and material according to the invention in the form of a fibre matrix (S/T1; S/T2; S/T3; S/T4=fibre matrix type I, type II, type III, type IV) in human endothelial cells taking into account the staining of the microvessels with an anti-CD31 antibody. K=negative control; *=p<0.05 relative to the control (Student t-test).

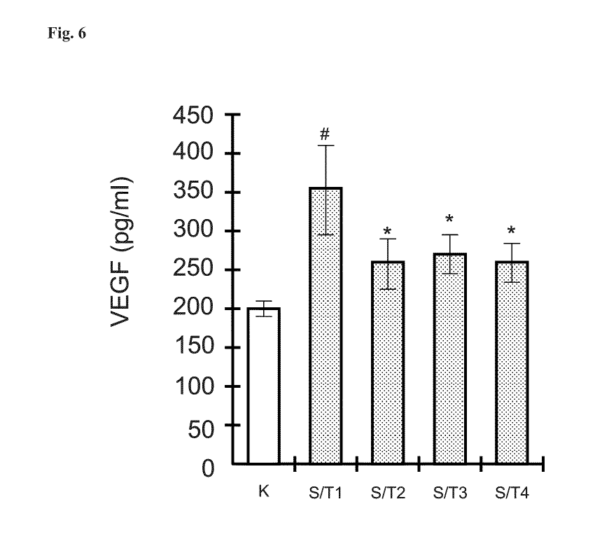

FIG. 6 Quantitative analysis the VEGF concentration of cell culture supernatants of human endothelial cells in the absence (control=K) and presence of different materials according to the invention in the form of a fibre matrix (nonwoven fabric; (S/T1; S/T2; S/T3; S/T4=fibre matrix type I, type II, type III, type IV)); #=p<0.05 compared to the control and relative to fibre matrix type II to IV (ANOVA Tukey test); *=p<0.05 compared to control (Student t-test).

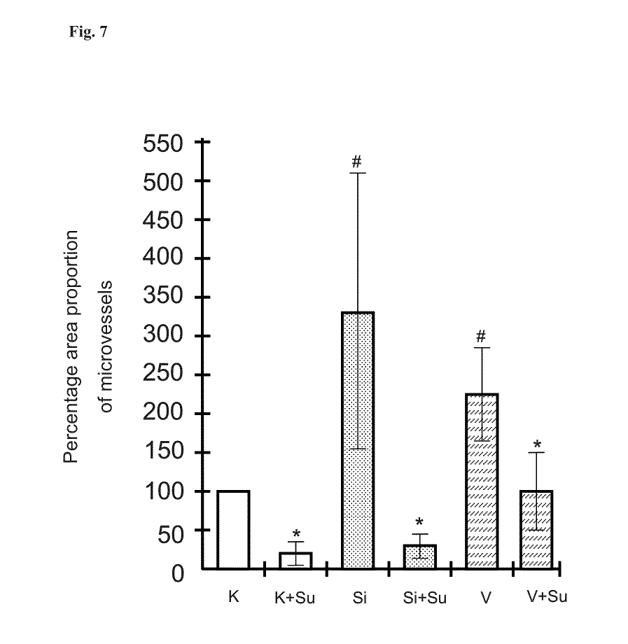

FIG. 7: Quantitative analysis of the effect of surmarin on neo-angiogenesis in human endothelial cells taking into account the staining of the microvessels with an anti-CD31 antibody in a control (K=only human endothelial cells; K+Su=human endothelial cells and addition of surmarin), with addition of the material according to the invention (Si=only material according to the invention and Si+Su=material according to the invention and surmarin) and addition of VEGF (V=addition of VEGF and V+Su=addition of VEGF and surmarin). #=p<0.05 compared to the control (ANOVA Tukey test), *=p<0.05 compared to cultures without surmarin (Student t-test); FIG. 7 shows that the materials according to the invention induce angiogenesis via VEGF. When the material according to the invention (Si) is present, an approx. 3.5-fold increase (compared to the control; approx. 350%) in the percentage area proportion of microvessels is observed. This effect can be increase with surmarin.

### EXAMPLES

### 1. Production of Fibre Matrices According to the Invention from Polyhydroxysilicic Acid Ethyl Ester

As educt for the hydrolysis-condensation reaction, 1124.98 g TEOS (tetraethoxysilane) was put in a stirred vessel. 313.60 g EtOH was added as solvent. The mixture is stirred. Separately, 1 n HNO₃ (55.62 g) was diluted with H₂O (120.76 g) and was added to the TEOS-ethanol mixture. The mixture was stirred for 18 hours.

The mixture obtained by this step was then evaporated at temperatures of 62° C. with feed of a carrier stream and stirring (60 rev/min) to a dynamic viscosity (shear rate 10 s-1 at 4° C.) of 1 Pa·s.

The solution was then matured in a closed polypropylene maturation beaker at rest and upright at a temperature of 4° C. to a dynamic viscosity of approx. 55 Pa·s (shear rate 10 s-1 at 4° C.) and a loss factor of 3.0.

The sol resulting from maturation was then spun into fibre. The production of the fibres was carried out in a usual spinning apparatus. For this, the spinning material was filled in a pressure cylinder cooled to −15° C. The spinning material was forced under pressure through the nozzles. The free-flowing, honey-like material fell under its own weight into a spinning shaft with length of 2 m located under the pressure cylinder. Temperature and humidity were controlled in the spinning shaft. The temperature was 25° C. and the air humidity was 19%. As the threads came onto the changing table, they practically retained their cylindrical shape, but were still flowable, so that at their contact surfaces they stuck together as bundles of fibres (nonwovens). The resultant spun fibres are exposed directly after spinning for a period of 35 minutes to the same climatic conditions as in the spinning tower (i.e. for example air humidity of 19%, temperature 25° C.) (conditioning of the spun fibres).

In total, 8 different fibre nonwoven materials were produced from polyhydroxysilicic acid ethyl ester (type I to IV, A1, A2, B1 and B2) produced. The spun fibres have a diameter of approx. 50 μm. The fibre nonwovens A1, A2, B1 and B2 differ by a different throughput in spinning (and accordingly the spinning time; see Table 1). The throughput shown in Table 1 in refers to the total sol throughput. The pressure in the spinning vessel is adjusted so that the desired throughput is achieved.

TABLE 1
Throughput and spinning time of fibre matrices according
to the invention made from polyhydroxysilicic acid ethyl ester

| | Type I to IV | A1 | A2 | B1 | B2 |
|---|---|---|---|---|---|
| Throughput | Approx. | Approx. | Approx. | Approx. | Approx. |
| | 80 g/h | 57 g/h | 99 g/h | 58 g/h | 97 g/h |
| Spinning | 6.15 min | 8.5 min | 5.25 min | 12.2 min | 7.8 min |
| time per | | | | | |
| nonwoven | | | | | |
| (5 cm × 5 cm) | | | | | |

The fibre nonwovens type I, type II, type III and type IV differ in that after the conditioning step described above and packaging of the nonwoven materials for storage until they were used, they were exposed for different lengths of time to an environment with an air humidity of 35% to 55% (see Table 2). During storage of the nonwovens in the packaging, the air humidity in the packaging is greatly reduced through the presence of absorbents. Suitable packaging for storing the fibre nonwovens are described for example in European patent application EP09007271.

TABLE 2
Different production of fibre matrices according to
the invention from polyhydroxysilicic acid ethyl ester.
For the stated time, the nonwovens are exposed to the following
environment: temperature: 25° C.; air humidity 35% to 55%

| | | | Type | Type | A1/A2/ |
|---|---|---|---|---|---|
| | Type I | Type II | III | IV | B1/B2 |
| Time between the end | 1-10 | approx. | approx. | approx. | 1-10 min |
| of conditioning and | min | 2 h | 6 h | 24 h | |
| storage in conditions | | | | | |
| with greatly reduced | | | | | |
| air humidity | | | | | |

TABLE 3
Different product properties of fibre matrices according to the
invention made from polyhydroxysilicic acid ethyl ester

| | | Thickness of | | Content |
|---|---|---|---|---|
| | | wound | | of ethoxy |
| | Mass | dressing | Compressibility | groups |
| Type 1 | 420 mg | 1.7 mm | 21% | 26.1% |
| Type II | 390 mg | 1.7 mm | 16% | 17.3% |
| Type III | 380 mg | 1.7 mm | 15% | 12.7% |
| Type IV | 365 mg | 1.7 mm | 13% | 6.6% |
| A1 | 436 mg | 2.0 mm | 26% | 26.8% |
| A2 | 419 mg | 1.5 mm | 17% | 26.8% |
| B1 | 622 mg | 2.8 mm | 26% | 26.8% |
| B2 | 620 mg | 2.0 mm | 15% | 26.8% |

The different production conditions led to different nonwoven fabric properties in particular with respect to compressibility and the ethoxy content of the nonwovens after spinning (see Table 3).

The compressibility was measured by thicknesses measurements (precision thickness measuring instrument Model 2000, from Wolf Messtechnik GmbH) with the process steps described in the description, and calculated.

The content of ethoxy groups was measured by the standard method of ether cleavage according to Zeisel. A solution of the internal standard was added to the fibre matrix to be analysed, and after adding hydriodic acid was heated for one hour in a gas-tight sealed glass vessel at 120° C. Any ethoxy groups present are converted to ethyl iodide. The resultant ethyl iodide is determined by gas chromatography, and evaluation is based on the method of the internal standard. The standard is toluene.

### 2. Neo-Angiogenesis in Human Endothelial Cells

Test set-up: The angiogenesis assay kit from the company TCS Cellworks (Buckingham, UK) was used for determining the neo-angiogenesis. 24-well cell culture plates were used, the bottoms of which were covered to confluence with a cell lawn consisting of human fibroblasts and human endothelial cells. All cell culture media required for carrying out the test and antibodies for detecting endothelial cell-specific surface antigens (CD31, von Willebrand factor=vWF) were also obtained from TCS Cellworks. For carrying out the tests, in addition plastic hangers suitable for 24-well cell culture plates were used, which can be loaded with different substrates. The contents of the plastic hangers are separated by a membrane from the cell culture medium. However, owing to the permeability of the membrane, exchange of dissolved substances is possible between the contents of the hangers and the cell culture medium.

Test procedure: The cells in the wells of the culture plate to be investigated were covered with 300 μl of cell culture medium per well. Then all the wells were fitted with the plastic hangers. In the case of testing of the polyhydroxysilicic acid ethyl ester compound, in each case 1 cm² of a polyhydroxysilicic acid ethyl ester fibre matrix was inside in the hangers and covered with 350 μl of medium. In controls, the hangers were supplemented with 350 μl medium, in the positive controls the hangers were supplemented with 350 μl medium+2 ng/ml VEGF and in the negative controls the hangers were filled with 350 μl medium+20 μg/ml suramin, a potent VEGF inhibitor. The culture plates were cultivated for 7-12 days, with a complete or partial exchange of the medium or the contents of the medium every three days. In the quantitative analysis of the effect of surmarin on neo-angiogenesis in human endothelial cells shown in FIG. 7, surmarin was applied simultaneously with the polyhydroxysilicic acid ethyl ester fibre matrix (see Si+Su) or VEGF (see V+Su).

Evaluation: To determine the rate of angiogenesis, after 7 to 12 days of culture, the hangers and media were removed from the cell culture plates and the cells grown to confluence were fixed on the bottom of the cell culture plate in accordance with the manufacturer's instructions. For showing microvessel formation, the fixed preparations were stained by means of the endothelial cell-specific antibody in accordance with the manufacturer's instructions. Similarly, using a VEGF-ELISA kit (R&D Systems, Abingdon, UK), the concentration of VEGF was determined in all the test supernatants obtained.

Results: After staining the respective cultures with endothelial cell-specific antibody, it could be seen that in cultures that were incubated with the polyhydroxysilicic acid ethyl ester fibre matrix, the density of microvessel formation, both after staining with CD31 (FIG. 1), and after staining with the vWF-specific antibody (FIG. 2), was higher than in the untreated controls and was comparable to or greater than microvessel formation in the VEGF-containing positive controls.

For quantitative determination of the aforementioned observations, the digital photographs of the test results were evaluated densitometrically by means of the “ImageJ” image-processing software. As shown in FIGS. 3 to 5, the relative density of vessels is significantly higher in samples that were treated with polyhydroxysilicic acid ethyl ester fibre matrices, than in the control cultures and is comparable to cultures that were maintained in the presence of VEGF.

To analyse the effect of polyhydroxysilicic acid ethyl ester fibre matrices on endothelial VEGF synthesis, the aforementioned tests were extended to 12 days, and to maintain cell vitality, the culture medium was not exchanged, but was extended every 4 days with fresh medium. In this way it was possible to find the cumulative amount of VEGF of the complete test, and therefore find amounts of VEGF that were well above the limit of detection of the tests. As shown in FIG. 6, the incubation of endothelial cells with polyhydroxysilicic acid ethyl ester fibre matrices leads to significantly increased VEGF synthesis in the assay, wherein polyhydroxysilicic acid ethyl ester fibre matrices of type I induced significantly increased VEGF production, compared to the other silica types.

The term “vessel density” denotes the area in the culture plate covered by newly formed capillary structures, relative to the total area. The vessel density is measured by densitometric determination of the proportions of black pixels in a black-and-white image of the capillary structures stained by specific antibodies compared to the white area of the plate background without capillary structures.

The term “percentage area of microvessels” describes what percentage of the empty area (control corresponds to 100%) is occupied by microvessels induced by neo-angiogenesis. This parameter was measured by densitometry. For this, black-and-white photographs of the cultures were investigated for their proportion of black pixels (=positive antibody staining of the endothelial cells).

### 3. In Vivo Tests for Neo-Angiogenesis of the Material According to the Invention

Polyhydroxysilicic acid ethyl ester fibre matrices According to the invention (A1, A2, B1 and B2) were compared in an animal model (pig; Middelkoop E, et al., Porcine wound models for skin substitution and burn treatment. Biomaterials. 2004 April; 25(9):1559-67) with the clinical gold standard (nSHT=net-like split-skin graft; MDM=Matriderm® from Dr. Suwelack Skin & Health Care AG.). For this, wounds 3×3 cm and 2.7 mm deep were created in Yorkshire pigs (open wounds of grade 3). The polyhydroxysilicic acid ethyl ester fibre matrices according to the invention (A1, A2, B1 and B2) and the controls were transplanted onto these open wounds and compared. Each matrix was applied on 4 different wounds. 13 days after transplantation, biopsies were taken from the wound area and immunohistochemistry was carried out. With respect to the blood vessels, the von Willebrand factor (vWF; Ulrich M M, et al., Expression profile of proteins involved in scar formation in the healing process of full-thickness excisional wounds in the porcine model. Wound Repair Regen. 2007 July-August; 15(4):482-90) stained with an antibody. The staining was evaluated by digital image analysis. The NIS-Ar Software (Nikon) was used for quantifying the results. Definitely increased staining (about 2.8-fold) of vWF regions by the material according to the invention was observed compared to the control (see Table 4).

1. A silicon-containing, biodegradable material for preventing and/or treating a disease associated with reduced and/or disturbed angiogenesis and/or disease for which an increased rate of angiogenesis is beneficial to the healing process, wherein the silicon-containing, biodegradable material is a polyhydroxysilicic acid ethyl ester compound, with the proviso that wound defects, comprising chronic diabetic-neuropathic ulcer, chronic leg ulcer, bedsores, secondary-healing infected wounds, non-irritating, primary-healing wounds, ablative lacerations and/or abrasions, are excluded from said disease that can be prevented and/or treated with said material.

2. The silicon-containing, biodegradable material according to claim 1, wherein the material is in the form of a fibre, a fibre matrix, powder, liquid formulation, monolith and/or coating.

3. The silicon-containing, biodegradable material according to claim 2, capable of being produced by:
a) at least one hydrolysis-condensation reaction of tetraethoxysilane;
b) evaporating to produce a single-phase solution optionally with simultaneous gentle mixing of reaction system;
c) cooling of the single-phase solution;
d) maturation for producing silica sol material; and
e) drawing threads from said silica sol material for generating a fibre or a fibre matrix and/or drying, optionally spray drying or freeze-drying of said silica sol material to generate a powder and optionally dissolving the powder in a solvent to generate a liquid formulation and/or coating an object that is to be coated with said material, and/or
casting said silica sol material in a mould to generate a monolith.

4. The silicon-containing, biodegradable material produced according to claim 3, wherein the tetraethoxysilane is acid-catalysed in a) at an initial pH from 0 to ≦7, optionally in the presence of a water-soluble solvent, optionally ethanol, at a temperature from 0° C. to 80° C.
and
in b) a single-phase solution is evaporated to a viscosity in a range from 0.5 to 2 Pa·s at a shear rate of 10 s 1 at 4° C.

5. silicon-containing, biodegradable material according to claim 4, wherein the acid catalysis in a) is carried out with aqueous solution of nitric acid in a molar ratio to the Si compound in a range 1:1.7 to 1:1.9, optionally in a range from 1:1.7 to 1:1.8.

6. The silicon-containing, biodegradable material of claim 1, wherein said disease is associated with reduced and/or disturbed angiogenesis and/or a disease for which an increased rate of angiogenesis is beneficial to the healing process is selected from the group consisting of:
a) diseases of the blood circulation and/or cardiovascular system comprising:
anaemia, angina pectoris, (peripheral) arterial occlusive disease, arteriosclerosis, Winiwarter-Buerger disease, myocardial infarction, ischaemia in particular of the heart muscle, of the lung, cardiomyopathy, congestive heart failure, coronary artery diseases such as coronary restenosis, hereditary haemorrhagic telangiectasia, hypercholesterolaemia, ischaemic heart disease, myocardial scleroderma, myointimal hyperplasia, blocked blood vessels, peripheral arteriosclerotic vascular disease, portal hypertension, preeclampsia, rheumatic heart disease, hypertension, thromboembolic diseases; and/or
b) diseases associated with bone, cartilage or muscle comprising:
bone/cartilage repair, bone defect, bone fracture, bone growth, cartilage diseases, intervertebral disc degeneration, osteoarthritis, osteoporosis, spinal fracture, fibromyalgia, polymyositis; and/or
c) diseases of the central nervous system comprising:
ischaemia in the central nervous system or in the peripheral nervous system, Alzheimer's, amyotrophic lateral sclerosis, autonomic neuropathy, aneurysms, cerebral infarction, stroke, cerebrovascular disease, cerebrovascular deficient perfusion, dementia, epilepsy, ischaemic peripheral neuropathy, mild cognitive deficits, multiple sclerosis, nerve damage, Parkinson's disease, Niemann-Pick disease, polyneuropathy, schizophrenia, spinal cord injuries, toxic neuropathy; and/or
d) diseases of the eye comprising:
glaucoma; retinopathy; and/or
e) gastrointestinal diseases comprising:
Crohn's disease, gastric ulcer, intestinal ischaemia, irritable bowel syndrome, pancreatitis, ulcerative colitis; and/or
f) hormonal or metabolic diseases comprising:
diabetes mellitus, diabetic foot, peripheral diabetic vascular disease; and/or
g) diseases of the immune system comprising:
allergies, mastocytosis, Sjögren disease, transplant rejection, tissue defects in collagenoses such as Sjögren syndrome, dermatomyositis, systemic lupus erythematosus, CREST syndrome, Sharp syndrome; and/or
h) infectious diseases comprising:
septic shock; and/or
i) kidneys diseases comprising:
nephropathy, intracranial hypertension, renal ischaemia; and/or
j) oral diseases comprising:
dental plaque, gum disease; and/or
k) diseases of the reproductive system comprising:
erectile dysfunction; and/or
l) diseases of the respiratory tract comprising:
asthma, bronchopulmonary dysplasia, pneumonia, respiratory distress syndrome; and/or
m) skin diseases comprising:
nonspecific dermatitis, decubitus ulcers, dermal ischaemia, dermal ulcers, diabetic gangrene, diabetic skin ulcers, lacerations, psoriasis, scleroderma, skin injuries, burns, surgical wounds, wound healing; and/or
n) vascular diseases comprising:
vascular insufficiency, vascular restenosis, vasculitis, vasospasm, Wegener's granulomatosis; and/or
o) other diseases comprising:
alopecia, lactate acidosis, limb ischaemias, hepatic cirrhosis, hepatic ischaemia, mitochondrial encephalomyopathy, sarcoidosis, soft tissue defect, diseases that are treated with autografts of tissues and/or organs.

7. The silicon-containing, biodegradable material according to claim 1, wherein the polyhydroxysilicic acid ethyl ester compound has a content of ethoxy groups of at least 20%.

8. The silicon-containing, biodegradable material according to claim 7, wherein the polyhydroxysilicic acid ethyl ester compound is in the form of a fibre and/or a fibre matrix and said fibre and/or fibre matrix has a compressibility of at least 17%.

9. A method for preventing and/or treating a disease associated with reduced and/or disturbed angiogenesis and/or disease for which an increased rate of angiogenesis is beneficial to healing, said method comprising utilizing a silicon-containing, biodegradable material comprising a polyhydroxysilicic acid ethyl ester compound, wound defects comprising chronic diabetic-neuropathic ulcer, chronic leg ulcer, bedsores, secondary-healing infected wounds, non-irritating, primary-healing wounds, ablative lacerations and/or abrasions, are excluded from said disease that can be prevented and/or treated with said material.

10. A method of claim 8, wherein said disease is selected from the group consisting of a) diseases of the blood circulation and/or cardiovascular system comprising:
anaemia, angina pectoris, (peripheral) arterial occlusive disease, arteriosclerosis, Winiwarter-Buerger disease, myocardial infarction, ischaemia in particular of the heart muscle, of the lung, cardiomyopathy, congestive heart failure, coronary artery diseases such as coronary restenosis, hereditary haemorrhagic telangiectasia, hypercholesterolaemia, ischaemic heart disease, myocardial scleroderma, myointimal hyperplasia, blocked blood vessels, peripheral arteriosclerotic vascular disease, portal hypertension, preeclampsia, rheumatic heart disease, hypertension, thromboembolic diseases; and/or
b) diseases associated with bone, cartilage or muscle comprising:
bone/cartilage repair, bone defect, bone fracture, bone growth, cartilage diseases, intervertebral disc degeneration, osteoarthritis, osteoporosis, spinal fracture, fibromyalgia, polymyositis; and/or
c) diseases of the central nervous system comprising:
ischaemia in the central nervous system or in the peripheral nervous system, Alzheimer's, amyotrophic lateral sclerosis, autonomic neuropathy, aneurysms, cerebral infarction, stroke, cerebrovascular disease, cerebrovascular deficient perfusion, dementia, epilepsy, ischaemic peripheral neuropathy, mild cognitive deficits, multiple sclerosis, nerve damage, Parkinson's disease, Niemann-Pick disease, polyneuropathy, schizophrenia, spinal cord injuries, toxic neuropathy; and/or
d) diseases of the eye comprising:
glaucoma; retinopathy; and/or
e) gastrointestinal diseases comprising:
Crohn's disease, gastric ulcer, intestinal ischaemia, irritable bowel syndrome, pancreatitis, ulcerative colitis; and/or
f) hormonal or metabolic diseases comprising:
diabetes mellitus, diabetic foot, peripheral diabetic vascular disease; and/or
g) diseases of the immune system comprising:
allergies, mastocytosis, Sjögren disease, transplant rejection, tissue defects in collagenoses such as Sjögren syndrome, dermatomyositis, systemic lupus erythematosus, CREST syndrome, Sharp syndrome; and/or
h) infectious diseases comprising:
septic shock; and/or
i) kidneys diseases comprising:
nephropathy, intracranial hypertension, renal ischaemia; and/or
j) oral diseases comprising:
dental plaque, gum disease; and/or
k) diseases of the reproductive system comprising:
erectile dysfunction; and/or
l) diseases of the respiratory tract comprising:
asthma, bronchopulmonary dysplasia, pneumonia, respiratory distress syndrome; and/or
m) skin diseases comprising:
nonspecific dermatitis, decubitus ulcers, dermal ischaemia, dermal ulcers, diabetic gangrene, diabetic skin ulcers, lacerations, psoriasis, scleroderma, skin injuries, burns, surgical wounds, wound healing; and/or
n) vascular diseases comprising:
vascular insufficiency, vascular restenosis, vasculitis, vasospasm, Wegener's granulomatosis; and/or
o) other diseases comprising:
alopecia, lactate acidosis, limb ischaemias, hepatic cirrhosis, hepatic ischaemia, mitochondrial encephalomyopathy, sarcoidosis, soft tissue defect, diseases that are treated with autografts of tissues and/or organs.

11. Pro-angiogenetic therary method comprising utilizing a silicon-containing, biodegradable material comprising a polyhydroxysilicic acid ethyl ester compound.
